(19) United States
(12) Patent Application Publication
(10) Pub. No.: US 2014/0271446 A1
(43) Pub. Date: Sep. 18, 2014

(54) Catalyst for direct synthesis of hydrogen peroxide

(71) Applicant: SOLVAY SA, Brussels (BE)

(72) Inventors: Frédérique J. Desmedt, Brussels (BE); Jean-Pierre Ganhy, Brussels (BE); Yves Vlasselaer, Leefdaal (BE); Pierre Miquel, Brussels (BE)

(21) Appl. No.: 14/355,221

(22) PCT Filed: Nov. 6, 2012
(86) PCT No.: PCT/EP2012/071916

§ 371 Date: Apr. 30, 2014

(30) Foreign Application Priority Data
Nov. 7, 2011 (EP) 11188049.8

(51) Int. Cl. B01J 27/195; C01B 15/029; B01J 23/648

(52) U.S. Cl. CPC B01J 27/195; B01J 23/6484; C01B 15/029; B01J 23/6486
USPC 423/584; 502/213; 502/339; 502/246

(57) ABSTRACT

A catalyst comprising: a platinum group metal, silver or gold, and a carrier containing niobium or tantalum oxide or niobium or tantalum phosphate, and an oxide other than niobium or tantalum oxide, as well as its use in production of hydrogen peroxide. A process for producing hydrogen peroxide, comprising reacting hydrogen and oxygen in the presence of such catalyst in a reactor, and a process for producing such catalyst.

### TECHNICAL FIELD

This invention is related to a catalyst comprising: a platinum group metal, silver or gold, and a carrier containing niobium oxide or niobium phosphate, and an oxide other than niobium oxide, as well as a process for producing the catalyst of the invention. The invention also relates to its use in production of hydrogen peroxide and a process for producing hydrogen peroxide, comprising reacting hydrogen and oxygen in the presence of the catalyst according to the invention.

The invention also relates to a similar catalyst, process and use but where niobium is replaced by tantalum.

### STATE OF THE ART

Hydrogen peroxide is a highly important commercial product widely used as a bleaching agent in the textile or paper manufacturing industry, a disinfecting agent and basic product in the chemical industry and in the peroxide compound production reactions (sodium perborate, sodium percarbonate, metallic peroxides or percarboxyl acids), oxidation (amine oxide manufacture), epoxidation and hydroxylation (plasticizing and stabilizing agent manufacture). Commercially, the most common method to produce hydrogen peroxide is the “anthraquinone” process. In this process, hydrogen and oxygen react to form hydrogen peroxide by the alternate oxidation and reduction of alkylated anthraquinones in organic solvents. A significant disadvantage of this process is that it is costly and produces a significant amount of by-products that must be removed from the process.

One highly attractive alternative to the anthraquinone process is the production of hydrogen peroxide directly by reacting hydrogen and oxygen in the presence of metal catalysts supported on various oxides such as silica as a catalyst carrier.

However, in these processes, when a catalyst based on silica as carrier is used for the direct synthesis of hydrogen peroxide, the reaction product, i.e., hydrogen peroxide was not efficiently produced since the production of water as a by-product was very high and even higher than the hydrogen peroxide production after a certain period of time. To prevent these drawbacks, alternative processes with niobium oxide (Nb₂O₅) or Nb₂O₅.H₂O, which is also called niobic acid, instead of silica have been proposed (Pham, Hien N., et al., Applied catalysis A: General 397(2011) pp. 153-162). Those supported onto the niobic acid-based carriers for the direct synthesis of hydrogen peroxide are more selective because of the acidity of their surface which could stabilize the hydrogen peroxide produced but the hydrogen peroxide production remains very low and the final concentration in hydrogen peroxide is still low.

In US 2007/0142651 A1, the use of a catalyst comprising a polymer-encapsulated combination of noble metal and ion exchange resin is described.

In EP 0 621 235 A1, Mitsubishi Gas Chemical Company describes the use of catalysts based on solid acid as SnO₂—Nb₂O₅. Asahi Glass Chemical Co describes the use of catalysts based on a platinum metal and supported by carrier with at least one sort of elements chosen from the rare earth (titanium, niobium, nickel, molybdenum and tungsten). The carrier described is a mesoporous molecular sieve (JP2003010693 and JP2003024794). Those carriers are well-known and have been broadly described (Chemical Reviews, 1999, Vol. 99, N° 12, 3603-3624).

U.S. Pat. No. 6,441,203 relates to a liquid-phase epoxidation process using a supported catalyst containing palladium on a niobium-containing support.

U.S. Pat. No. 5,496,532 relates to a process for catalytically producing hydrogen peroxide using a platinum-group metal catalyst supported on a carrier comprising at least one oxide selected from the group consisting of niobium oxide, tantalum oxide, molybdenum oxide or a tungsten oxide. In example 11 of this document a support material being a dispersion of about 40 wt. % of niobium oxide in about 60 wt. % of silica is employed. This document teaches and claims the fact of obtaining niobium oxide and tantalum oxide by heat treating the corresponding acids at a temperature of 300 to 700° C. In example 19, a support material being a dispersion of about 49 wt % of tantalum oxide in about 51 wt % of silica is employed. The catalysts of these examples (11 and 19) are less performing than those using pure niobium or tantalum oxide.

EP 0 501 265 A1 describes a process for the preparation of cyclohexyl amine using a ruthenium or palladium containing catalyst being supported on niobium acid, tantalum acid or a mixture thereof.

However, all those prior art processes still do not exhibit sufficiently high productivity (such as less than 2% Wt H₂O₂ produced) and selectivity for producing hydrogen peroxide, and in consequence there have been demands for a novel catalyst which does not exhibit such disadvantages.

### DETAILED DESCRIPTION OF THE INVENTION

The expression “carrier” intends herein to denote the material, usually a solid with a high surface area, to which a catalytic compound is affixed and the carrier may be inert or participate in the catalytic reactions.

The expression “niobium oxide” intends herein to refer to oxide compounds of niobium such as niobium monoxide (NbO), niobium dioxide (NbO₂), niobium pentoxide (Nb₂O₅), etc.

The expression “niobium phosphate” intends herein to refer to phosphated compounds of niobium such as niobium phosphate (NbOPO₄xnH₂O), layered acid niobium phosphate Nb₂(OH)₂(HPO₄)(PO₄)₂x4.4H₂O, alkali metal niobium phosphate NaNb₂(OH)₂(PO₄)₃x2.5H₂O, acid niobium phosphate HNb₂(OH)₂(PO₄)₃xH₂O, etc.

Equivalent definitions apply to tantalum oxide and phosphate.

The object of the invention is to provide a catalyst for producing hydrogen peroxide from hydrogen and oxygen which does not present the above disadvantages and which enables to efficiently obtain hydrogen peroxide. Another object of the invention is to provide a process for producing the catalyst of the invention, and to provide an efficient process for producing hydrogen peroxide using the catalyst of the invention.

The present invention therefore relates to a catalyst comprising a platinum group metal, silver, gold or a mixture thereof, and a carrier containing niobium oxide or niobium phosphate, wherein the carrier contains more than 5 wt. % of an oxide other than niobium oxide, based on the total weight of the oxides or on the total weight of the oxide and the niobium phosphate. The present invention is also directed to its use in production of hydrogen peroxide, a process for producing hydrogen peroxide, comprising: reacting hydrogen and oxygen in the presence of the catalyst of the invention in a reactor, as well as a process for producing the catalyst of the invention.

The present invention also relates to catalyst comprising:
at least one catalytically active metal selected from a platinum group metal, silver, gold or a mixture thereof, and
a carrier containing niobium or tantalum oxide or niobium or tantalum phosphate,
wherein the carrier contains at least 65 wt. % of an oxide other than niobium or tantalum oxide, based on the total weight of the oxides or on the total weight of the oxide and niobium or tantalum phosphate, and wherein the niobium or tantalum oxide or phosphate is precipitated onto the oxide other than niobium or tantalum oxide.

The inventors have surprisingly discovered that by using a catalyst comprising a carrier based on a combination of niobium oxide or niobium phosphate, and an oxide other than niobium oxide such as silica, both high-productivity and selectivity are obtained in the direct reaction between hydrogen and oxygen. The same applies when niobium is replaced by tantalum, a metal having very similar physical and chemical properties.

In one preferred embodiment of the present invention, the catalyst comprises at least one metal selected from among the platinum group comprised of ruthenium, rhodium, palladium, osmium, iridium, platinum, or any combination of these metals. In a more preferred embodiment, the catalyst comprises a palladium metal or a combination of palladium with another metal (for example, platinum, silver or gold).

The amount of platinum group metal, silver or gold supported on the carrier can vary in a broad range, but be preferably comprised from 0.001 to 10 wt. %, more preferably from 0.1 to 5 wt. %, preferably from 0.5 to 3 wt % and most preferably from 0.4 to 3 wt. %, each based on the weight of the carrier. The addition of the metal to the carrier can be performed using any of the known preparation techniques of supported metal catalyst, e.g. impregnation, adsorption, ionic exchange, etc. For the impregnation, it is possible to use any kind of inorganic or organic salt of the metal to be impregnated that is soluble in the solvent used. Suitable salts are for example halides such as chloride, acetate, nitrate, oxalate, etc.

In the catalyst according to the invention, the catalytically active metal is preferably present at least partly in reduced form. In the context of that embodiment of the present invention, a metal in reduced form means metal atoms having the oxidization level 0 or lower, such as Pd⁰ or Pd hydride.

One of the essential features of the present invention resides in the use of a combination of niobium/tantalum oxide or niobium/tantalum phosphate, and an oxide other than niobium/tantalum oxide such as silica as a carrier along with a platinum group metal, silver or gold to achieve the purpose of the invention. It has indeed been found that by using the catalyst according to the invention hydrogen peroxide is efficiently obtained, with improved productivity and selectivity towards the reaction product which is hydrogen peroxide. Moreover, this selectivity remains stable even at a high concentration of hydrogen peroxide, for example higher than 10% by weight and it remains quite stable during the entire process.

The oxide other than niobium/tantalum oxide may be any oxide known in the art but preferably is selected from the group consisting of silica, alumina, titanium oxide, barium oxide, zirconium oxide, and mixtures thereof. In a preferred embodiment, the oxide other than niobium/tantalum oxide comprises silica. In a preferred embodiment the carrier does not contain SnO₂—Nb₂O₅. The presence of niobium/tantalum oxide such as Nb₂O₅ or niobium/tantalum phosphate such as NbOPO₄xnH₂O is essential since it reduces the production of a side product such as water during the H₂O₂ direct synthesis.

According to the present invention, the amount of oxide other than niobium/tantalum oxide in the carrier is at least 65 wt. %. Furthermore, the oxide other than niobium/tantalum oxide in the carrier may be present in an amount of up to 99 wt. %, preferably up to 98 wt. %, more preferably up to 96 wt. %, and most preferably up to 90 wt. %, such as 85 wt. % or 80 wt. %. For example, the amount of the oxide other than niobium/tantalum oxide in the carrier may range from 65 to 95 wt. %, and most preferably from 70 to 95 wt. %, such as from 70 to 94 wt. % or from 70 to 85 wt. %.

The Nb or Ta content of the catalyst according to the invention, measured by ICP-OES (Inductively Coupled Plasma Optical Emission Spectrometry), is preferably between 2 and 20 wt. %, more preferably between 4 and 15 wt. %

The preparation of the carrier containing niobium/tantalum oxide or niobium/tantalum phosphate, and an oxide other than niobium/tantalum oxide may be accomplished by impregnating an oxide other than niobium or tantalum oxide with a niobium or tantalum compound (e.g., Nb(OCH₂CH₃)₅), optionally followed by drying. The niobium compounds include any suitable niobium halide, niobium alkoxide, or niobium halide alkoxide (such as NbCI₃(OCH₂CH₃)₂). The same applies for the tantalum compound. In preferred embodiments niobium oxide (Nb₂O₅) is precipitated onto silica to form a mixture of those metal oxides.

The preparation of the carrier containing niobium or tantalum phosphate, and an oxide other than niobium or tantalum oxide may be accomplished by a variety of techniques known in the art. In a preferred embodiment, the precursor of niobium or tantalum phosphate is niobium or tantalum oxide. One such method involves starting form the carrier already impregnated with niobium or tantalum oxide and treated with ortho-phosphoric acid e.g. at room temperature and optionally followed by drying.

The oxides can essentially be amorphous like a silica gel or can be comprised of an orderly structure of mesopores, such as, for example, of types including MCM-41, MCM-48, SBA-15, among others or a crystalline structure, like a zeolite.

The platinum group metal, silver or gold used in the invention may be deposited by various ways known in the art. For example, the metal can be deposited by dipping the carrier to a solution of halides of the metal followed by reduction. In more specific embodiments, the reduction is carried out in the presence of a reducing agent, preferably gaseous hydrogen preferably at high temperature.

The catalyst according to the invention preferably has a large specific surface area measured by the BET method, generally greater than 20 m²/g, preferably greater than 100 m²/g. Moreover, the catalyst can essentially have an amorphous structure. In particular the niobium/tantalum oxide, niobium/tantalum phosphate and/or the oxide other than niobium/tantalum oxide can have an amorphous structure. Preferably, the niobium/tantalum oxide or niobium/tantalum phosphate and the oxide other than niobium/tantalum oxide can have an amorphous structure. Typically, the mean particle size of the catalyst ranges from 50 μm to a few mm, preferably from 60 to 210 μm.

In the second aspect of this invention, the invention is also directed to the use of the catalyst according to the invention in production of hydrogen peroxide. In the process of the invention, hydrogen and oxygen (as purified oxygen or air) are reacted continuously over a catalyst in the presence of a liquid solvent in a reactor to generate a liquid solution of hydrogen peroxide. The catalyst is then used for the direct synthesis of hydrogen peroxide in a three phase's system: the catalyst (solid) is put in a solvent (water or alcohol) and the gases (H₂, O₂ and an inert gas) are bubbled in the suspension in presence of stabilizing additives (halides and/or inorganic acid).

In the third aspect of the invention, a process for producing hydrogen peroxide, comprising: reacting hydrogen and oxygen in the presence of the catalyst according to the invention in a reactor, is provided. The process of this invention can be carried out in continuous, semi-continuous or discontinuous mode, by the conventional methods, for example, in a stirred tank reactor with the catalyst particles in suspension, in a basket-type stirred tank reactor, in a fixed bed, etc. Once the reaction has reached the desired conversion levels, the catalyst can be separated by different known processes, such as, for example, by filtration if the catalyst in suspension is used, which would afford the possibility of its subsequent reuse. In the case of a stirred bed, the amount of catalyst used is that necessary to obtain a concentration 0.01 to 10 wt. % regarding the total mass (liquid +solid) and preferably being 0.02 to 5 wt. %. The concentration of the obtained hydrogen peroxide according to the invention is generally higher than 5 wt. %, preferably higher than 8 wt. %, most preferably higher than 13 wt. %.

In addition to their catalytic properties for the reaction of direct synthesis of the hydrogen peroxide, the catalysts of the invention are unfortunately also decomposition and over-hydrogenation catalysts of the peroxide formed. It is consequently advantageous for the liquid phase in which the synthesis is carried out, to contain a compound capable of poisoning the hydrogen peroxide decomposition and over-hydrogenation sites present on the surface of the catalyst. Halide ions are good representatives of these compounds. Their optimum concentration must be determined by means of laboratory tests within the capability of the person skilled in the art. This concentration must be sufficient in order to achieve poisoning the majority of the decomposition sites of the catalyst and, at the same time, not too high in order to avoid as much as possible the oxidation reaction of the halide ion by the hydrogen peroxide. Chloride, bromide and iodide ions are suitable to inhibit the decomposition and the over-hydrogenation sites of the catalyst. The bromide ion has given the best results, especially when present in a concentration of between 0.05 and 3 mmol/l of liquid phase and, preferably, between 0.1 and 2 mmol/l.

Preferably, the DS (Direct Synthesis) of hydrogen peroxide according to the invention is carried out in the absence of any inorganic acid in the liquid phase. This is an advantage over prior art catalysts which require the use of such an acid, which is expensive and can lead to corrosion problems.

In the last aspect of the invention, the invention relates to a process for producing the catalyst of the invention, comprising: (i) adding to an oxide other than niobium/tantalum oxide a precursor of niobium/tantalum oxide or a precursor of niobium/tantalum phosphate to form a homogeneous mixture, (ii) converting the precursor of niobium/tantalum oxide or the precursor of niobium/tantalum phosphate to niobium/tantalum oxide or niobium/tantalum phosphate, respectively, to produce a carrier, and (iii) depositing a platinum group metal, silver, gold or a mixture thereof onto the carrier.

In preferred embodiment, the precursor of niobium/tantalum oxide is an alkoxylate of niobium/tantalum, preferably niobium/tantalum ethoxide. The precursor is converted, for example after hydrolysis, to niobium/tantalum oxide, which can be precipitated onto the support of an oxide other than niobium/tantalum oxide to produce a carrier. A platinum group metal such as palladium which acts as active material in the direct synthesis of hydrogen peroxide is deposited on these oxides of niobium/tantalum.

The deposition of the platinum group metal onto the carrier can be performed using any of the known preparation techniques of supported metal catalyst, e.g. impregnation, adsorption, ionic exchange, etc. For the impregnation, it is possible to use any kind of inorganic or organic salt of the metal to be impregnated that is soluble in the solvent used. Suitable salts are for example halides such as chloride, acetate, nitrate, oxalate, etc. For example, the metal can be deposited by dipping the carrier to a solution of halides of the metal followed by reduction. Generally, the catalysts of the invention do not require calcination (thermal oxidation) to be effective, which is advantageous from an energetic point of view.

After the metal has been deposited on the support material, the product is recovered, for example by filtration, washed and dried. Subsequently, the metal deposited on the support is preferably (at least partially) reduced, for example by using hydrogen (eventually diluted with nitrogen) at elevated temperature. This hydrogenation step can be carried out for example at a temperature of 100° C. to 300°, preferably of 150° C. to 200° C. for 1 to 10 hours, preferably from 2 to 6 hours.

Throughout the description and the claims, the word “comprises” and the variations thereon do not intend to exclude other technical features, additives, components or steps. For the experts in this field, other objects, advantages and characteristics of the invention will be inferred in part from the description and in part from the embodiment of the invention. The following examples are provided for illustrative purposes and are not intended to be limiting of the present invention.

### EXAMPLES

### Example 1

Silica was dried overnight at 160° C. in an oven. In a three necks flask, equipped with nitrogen flushing, 300 mL of dried n-hexane (Aldrich, of purity >99%) and 6.23 g of niobium ethoxide (Nb(OC₂H₅)₅ (Aldrich, 99.95%)) were introduced. The suspension was maintained under mechanical stirring at room temperature. 19.69 g of dried silica were introduced in the flask and maintained under stirring during three hours. The solvent was evaporated under vacuum using a rotary evaporator. 100 mL of demineralized water were added to the solid. 20 mL of a solution of nitric acid 0.5M were added to the suspension slowly. The carrier was aged overnight at room temperature, and then it was dried under vacuum with a rotary evaporator. The carrier was washed with demineralized water and dried for 24 hours at 160° C.

A sample of 12.23 g of the carrier was taken for the catalyst preparation. In 12 ml of demineralized water, 0.4070 g of palladium chloride was introduced. Some drops of HCl 35 wt. % aqueous solution were added to the mixture to help the dissolution and the medium was heated at 50° C. under magnetic stirring until all the salt was dissolved. The solution was added to the carrier and was well mixed until all the liquid phase was adsorbed by the carrier. The obtained catalyst was dried at 95° C. for 24 hours. Palladium was reduced under influence of a mixture of hydrogen and nitrogen at 175° C. during 20 hours.

### Example 2

A catalyst was prepared as in Example 1, except that 6.93 g of niobium ethoxide and 20 g of SiO₂ were used.

The surface area of silica, which was determined by BET, was 316 m²/g and the silica had an amorphous structure. The diameter of the particles determined by a scanning electron microscope(SEM) was around 200 micrometer. The catalyst had a surface area of 316 m²/g, which was determined by BET, and exhibited amorphous structure. The diameter of the particles determined by SEM was between 80 and 250 micrometer. The Nb content was determined and reached 10 wt. %. The Pd content was determined by inductively coupled plasma optical emission spectrometry (ICP-OES) and reached 2.0 wt. %.

### Comparative Example 1

1 g of a solution of palladium chloride (19.9 wt. % in Pd) was diluted in 19 g of demineralized water. The solution was put in contact with 20 g of silica. The obtained catalyst was dried overnight at 75° C. Palladium was reduced under influence of a mixture of hydrogen and nitrogen at 125° C. during 8 hours. Pd content was determined by ICP-OES and reached 0.91 wt. %.

### Comparative Example 2

A catalyst containing 2 wt. % Pd on niobic acid was obtained by an external source.

### Example 3

Silica was dried overnight at 160° C. in an oven. In a three necks flask, equipped with nitrogen flushing, 300 mL of dried n-hexane (Aldrich, of purity >99%) and 8.38 g of niobium ethoxide (Nb(OC₂H₅)₅ (Aldrich, 99.95%)) were introduced. The suspension was maintained under mechanical stirring at room temperature. 24.81 g of dried silica were introduced in the flask and maintained under stirring during three hours. The solvent was evaporated under vacuum using a rotary evaporator. 125 mL of demineralized water were added to the solid. 30 mL of a solution of nitric acid 0.5M were added to the suspension slowly. The carrier was aged overnight at room temperature, and then it was dried under vacuum with a rotary evaporator. The carrier was washed with demineralized water and dried for 24 hours at 160° C.

15.39 g of the carrier is introduced in a beaker of 100 ml. 1.59 g of ortho-phosphoric acid 85% Wt is introduced and 50 ml of demineralized water. The suspension is mixed at room temperature during 48 hours (magnetic stirrer—400 rpm).

The suspension is heated to evaporate the water and the drying procedure is finalized by one night at 95° C. followed by 48 hours at 150° C.

The carrier is grinded.

A solution of palladium chloride in water is prepared with the amount of Pd necessary to obtain a loading of 2% Wt Pd on the catalyst. Typically the total volume of the solution for 20 g of carrier is 20 ml. Some drops of HCl are added to the suspension and the medium is heated at 50° C. under magnetic stirring until all the salt has been dissolved.

The solution is added to the carrier and well mixed until all the liquid phase has been adsorbed by the carrier. The catalyst is dried at 95° C. for 24 hours. The Pd is reduced under influence of hydrogen, diluted with nitrogen, during 3 hours at 150° C.

The surface area of silica, which was determined by BET, was 307 m²/g and the silica had an amorphous structure.

The Nb content was determined and reached 7.4 wt. %. The Pd content was determined by inductively coupled plasma optical emission spectrometry (ICP-OES) and reached 2.0 wt. %. P content was determined by inductively coupled plasma optical emission spectrometry (ICP-OES) and reached 2.30 wt. %.

### Example 4

A catalyst was prepared as in Example 3, except that 2.6589 g ortho-phosphoric acid and 25.06 g of the carrier prepared in the example 1 were used.

The Nb content was determined and reached 10 wt. %. The Pd content was determined by inductively coupled plasma optical emission spectrometry (ICP-OES) and reached 2.05 wt. %. P content was determined by inductively coupled plasma optical emissionspectrometry (ICP-OES) and reached 2.7 wt. %.

### Example 5

In a 380 mL Hastelloy B22 reactor, methanol (220 g), hydrogen bromide (35 ppm) and 2.06 g of a catalyst obtained in Examples 1 and 2 and Comparative Examples 1 and 2 were introduced. The reactor was cooled to 5° C. and the working pressure was at 50 bars (obtained by introduction of nitrogen). The reactor was flushed all the time of the reaction with the mixture of gases: hydrogen (3.6% Mol)/oxygen (25.0% Mol)/nitrogen (71.4% Mol). The total flow was 2567 mlN/min

When the gas phase out was stable (GC on line), the mechanical stirrer was started at 1200 or 1500 rpm. Gas Chromatography (GC) on line analyzed every 10 minutes the gas phase out. Liquid samples were taken to measure hydrogen peroxide and water concentration. Hydrogen peroxide was measured by redox titration with cerium sulfate. Water was measured by the Karl-Fisher titration method. The results are summarized Table 1.

TABLE 1

| | | | | Catalyst of | Catalyst of |
|---|---|---|---|---|---|
| | | | Catalyst of | Comp. | Comp. |
| | Catalyst of Example 1 | | Example 2 | Example 1 | Example 2 |
| Methanol (g) | 220.01 | 220.01 | 220.05 | 150.49 | 150.25 |
| HBr (ppm) | 34.9 | 34.9 | 34.9 | 51 | 20 |
| Catalyst (g) | 2.0614 | 2.0614 | 2.059 | 2.6675 | 0.8835 |
| Hydrogen | 3.6 | 3.6 | 3.6 | 3.5 | 3.5 |
| (mol. %) | | | | | |
| Oxygen | 25.0 | 25.0 | 25.0 | 35.1 | 35.1 |
| (mol. %) | | | | | |
| Nitrogen | 71.4 | 71.4 | 71.4 | 61.4 | 61.4 |
| (mol. %) | | | | | |
| Speed (rpm) | 1200 | 1200 | 1200 | 1500 | 1500 |
| Contact time | 390 | 720 | 420 | 225 | 240 |
| (min) | | | | | |
| Hydrogen | 9.69 | 13.45 | 7.98 | 2.88 | 0.97 |
| peroxide fin | | | | | |
| (wt. %) | | | | | |
| Water fin | 1.62 | 3.25 | 3.83 | 5.31 | 0.68 |
| (wt. %) | | | | | |
| Conversion | 58.2 | 44.0 | 51.2 | 46.0 | 6.3 |
| fin (%) | | | | | |
| Selectivity | 76.1 | 68.7 | 52.5 | 22.6 | 43.5 |
| fin (%) | | | | | |
| Productivity | 2339 | 1762 | 1792 | 1426 | 611 |
| fin (mol | | | | | |
| H₂O₂/(kg | | | | | |
| of Pd * h)) | | | | | |

### Example 6

In a 380 mL Hastelloy B22 reactor, methanol (220 g), hydrogen bromide (35 ppm) and 1.91 g of a catalyst obtained in Example 4 was introduced. The reactor was cooled to 5° C. and the working pressure was at 50 bars (obtained by introduction of nitrogen). The reactor was flushed all the time of the reaction with the mixture of gases: hydrogen (3.6% Mol)/oxygen (55.0% Mol)/nitrogen (41.4% Mol). The total flow was 3975 mlN/min

When the gas phase out was stable (GC on line), the mechanical stirrer was started at 1200 or 1500 rpm. Gas Chromatography (GC) on line analyzed every 10 minutes the gas phase out. Liquid samples were taken to measure hydrogen peroxide and water concentration. Hydrogen peroxide was measured by redox titration with cerium sulfate. Water was measured by the Karl-Fisher titration method. The results are summarized Table 2.

TABLE 2

| | Catalyst of |
|---|---|
| | Example 4 |
| Methanol (g) | 221.54 |
| HBr (ppm) | 34.7 |
| Catalyst (g) | 1.9063 |
| Hydrogen (mol. %) | 3.6 |
| Oxygen (mol. %) | 55.0 |
| Nitrogen(mol. %) | 41.4 |
| Speed(rpm) | 1200 |
| Contact time (min) | 240 |
| Hydrogen peroxide fin (wt. %) | 9.23 |
| Water fin (wt. %) | 2.63 |
| Conversion fin (%) | 46.9 |
| Selectivity fin (%) | 65.0 |
| Productivity fin (mol H₂O₂/(kg of | 3883 |
| Pd * h)) | |

Although this invention has been described broadly and also identifies specific preferred embodiments, it will be understood that modifications and variations may be made within the scope of the invention as defined by the following claims

### Example 7

### Preparation of a Calcined Catalyst

The support has been prepared following the recipe described for the Example 1. The support has been calcined at 450° C. during 8 h under air (temperature ramp 2° C/min) The support has been then impregnated with PdCl2 as described for the catalyst of Example 1 and reduced under influence of a mix hydrogen/nitrogen at 175° C. during 20 hours.

The Pd content is 2% Wt. The Nb content is 10% Wt.

### Hydrogen Peroxide Direct Synthesis in the Same Conditions as in Example 5

| | | Catalyst | Catalyst |
|---|---|---|---|
| | | of Example 1 | of Example 7 |
| Methanol | g | 220.01 | 222.72 |
| HBr | ppm | 34.9 | 34.9 |
| Catalyst | g | 2.0614 | 2.0154 |
| Temperature | ° C. | 5 | 5 |
| Pressure | bar | 50 | 50 |
| Hydrogen | % Mol | 3.6% | 3.6% |
| Oxygen | % Mol | 25.0% | 25.0% |
| Nitrogen | % mol | 71.4% | 71.4% |
| Total flow | mlN/min | 2567 | 2567 |
| Speed | rpm | 1200 | 1200 |
| Contact time | Min | 390 | 300 |
| Hydrogen | % Wt | 9.69 | 7.56 |
| peroxide fin | | | |
| Water fin | % Wt | 1.62 | 2.00 |
| Conversion fin | % | 58.2% | 54.7% |
| Selectivity fin | % | 76.1% | 67% |
| Productivity fin | mol H₂O₂/ | 2339 | 2481 |
| | (kg of Pd * h) | | |

### Example 8

Silica has been dried overnight at 160° C. in an oven.

In a three necks flask, equipped with nitrogen flushing, 400 cc of dried n-hexane and 10.00 g of tantalum ethoxide were introduced. The suspension was maintained under mechanical stirring at room temperature.

26.24 g of dried silica were introduced in the flask and maintained under stirring during three hours.

The solvent was evaporated under vacuum (rotavapor).

125 cc demineralized water were added to the solid. 30 cc of a solution of nitric acid 0.5M were added to the suspension slowly.

The carrier was aged overnight at room temperature, and then it was dried under vacuum (rotavapor).

The carrier was washed with demineralized water and dried overnight at 160° C.

A sample of 10.05 g of the carrier was taken for the catalyst preparation.

In 12 ml of demineralized water, 0.3463 g of palladium chloride was introduced. Some drops of HCl 35% Wt were added to the solution to help the dissolution.

The palladium was added to the carrier by incipient wetness.

Catalyst was dried during 48 hours at 95° C.

Palladium was reduced under influence of a mix hydrogen/nitrogen at 150° C. during 5 hours.

Ta content has been determined by ICP-OES and reaches 14% Wt.

Pd content has been determined by ICP-OES and reaches 1.80% Wt

### Comparative Example 3

A catalyst based on tantalum oxide has been prepared by incipient wetness method: 0.5 g of PdCl2 was dissolved in 10 ml of demineralized water (in presence of some drops of HCl). The solution has been put in contact with 19 g of Ta205. Catalyst has been dried overnight at 95° C.

Palladium was reduced under influence of a mix hydrogen/nitrogen at 150° C. during 5 hours.

Pd content has been determined by ICP-OES and reaches 1.50% Wt.

### Example 9

### Characterization of the Catalysts

The catalyst of example 8 has a surface area determined by BET of 308 m2/g. The diameter of the particles determined by SEM was between 100-200 microns.

The catalyst of comparative example 3 has a surface area determined by BET of 316 m2/g and is amorphous. The diameter of the particles determined by SEM is around 200 microns.

The catalyst of comparative example 4 has a surface area determined by BET of 5.3 m2/g. The diameter of the particles determined by SEM is less than 100 microns.

### Example 10

### Hydrogen Peroxide Direct Synthesis with the Catalyst of Example 8

| | | | |
|---|---|---|---|
| Methanol | g | 222.66 | 219.9 |
| HBr | ppm | 16.17 | 16.37 |
| Catalyst | g | 0.8025 | 0.8018 |
| H₃PO₄ | M | 0.1 | / |
| Temperature | ° C. | 5 | 5 |
| Pressure | bar | 50 | 50 |
| Hydrogen | % Mol | 3.6 | 3.6 |
| Oxygen | % Mol | 55.0 | 55.0 |
| Nitrogen | % mol | 41.4 | 41.4 |
| Total flow | mlN/min | 3975 | 3975 |
| Speed | rpm | 1200 | 1200 |
| Contact time | Min | 300 | 300 |
| Hydrogen peroxide fin | % Wt | 6.27 | 7.40 |
| Water fin | % Wt | 1.70 | 1.72 |
| Conversion fin | % | 10.9 | 26.2 |
| Selectivity fin | % | 70 | 71 |
| Productivity fin | mol H₂O₂/(kg of Pd * h) | 5703 | 6659 |

### Comparative Example 4

### Comparison with a Catalyst Based on Silica

| | | | Catalyst of |
|---|---|---|---|
| | | Catalyst of | Comp. |
| | | Example 8 | Example 1 |
| Methanol | g | 219.9 | 150.49 |
| HBr | ppm | 16.37 | 51 |
| Catalyst | g | 0.8018 | 2.6675 |
| Temperature | ° C. | 5 | 5 |
| Pressure | bar | 50 | 50 |
| Hydrogen | % Mol | 3.6% | 3.5% |
| Oxygen | % Mol | 55.0% | 35.1% |
| Nitrogen | % mol | 41.4% | 61.4% |
| Total flow | mlN/min | 3975 | 2567 |
| Speed | rpm | 1200 | 1500 |
| Contact time | Min | 300 | 225 |
| Hydrogen peroxide fin | % Wt | 6.27 | 2.88 |
| Water fin | % Wt | 1.70 | 5.31 |
| Conversion fin | % | 10.9% | 46.0% |
| Selectivity fin | % | 70% | 22.6% |
| Productivity fin | mol H₂O₂/(kg of Pd * h) | 5703 | 1426 |

### Comparative Example 5

### Comparison with a Catalyst Based on Tantalum Oxide

| | | | Catalyst of |
|---|---|---|---|
| | | Catalyst of | Comp. |
| | | Example 8 | Example 3 |
| Methanol | g | 219.9 | 154.41 |
| HBr | ppm | 16.37 | 20 |
| Catalyst | g | 0.8018 | 0.9636 |
| Temperature | ° C. | 5 | 5 |
| Pressure | bar | 50 | 50 |
| Hydrogen | % Mol | 3.6% | 3.6% |
| Oxygen | % Mol | 55.0% | 55.0% |
| Nitrogen | % mol | 41.4% | 41.4% |
| Total flow | mlN/min | 3975 | 2708 |
| Speed | rpm | 1200 | 1500 |
| Contact time | Min | 300 | 240 |
| Hydrogen peroxide fin | % Wt | 7.40 | 0.69 |
| Water fin | % Wt | 1.72 | 1.35 |
| Conversion fin | % | 26.2% | 1.3% |
| Selectivity fin | % | 71% | 21% |
| Productivity fin | mol H₂O₂/(kg of Pd * h) | 6659 | 541 |

1. A catalyst comprising:
at least one catalytically active metal selected from the group consisting of a platinum group metal, silver, gold, and a mixture thereof, and
a carrier containing niobium oxide, tantalum oxide, niobium phosphate, or tantalum phosphate,
wherein the carrier contains at least 65 wt. % of an oxide other than niobium oxide or tantalum oxide, based on the total weight of said oxides or based on the total weight of said oxide other than niobium oxide or tantalum oxide and said niobium phosphate or tantalum phosphate, and
wherein said niobium oxide, tantalum oxide, niobium phosphate, or tantalum phosphate is precipitated onto said oxide other than niobium oxide or tantalum oxide.

2. The catalyst according to claim 1, wherein said catalytically active metal is a platinum group metal.

3. The catalyst according to claim 1, wherein said carrier contains from 60 to 95 wt. % of said oxide other than niobium oxide or tantalum oxide.

4. The catalyst according to claim 1, wherein said oxide other than niobium oxide or tantalum oxide is selected from the group consisting of silica, alumina, titanium oxide, barium oxide, zirconium oxide, and mixtures thereof.

5. The catalyst according to claim 4, wherein said oxide other than niobium oxide or tantalum oxide comprises silica.

6. The catalyst according to claim 1, wherein said platinum group metal, silver, gold or mixture thereof is present in an amount of from 0.001 to 10 wt. %, each based on the weight of said carrier.

7. The catalyst according to claim 1, being obtainable by depositing at least one metal selected from the group consisting of a platinum group metal, silver, gold, and a mixture thereof by dipping said carrier into a solution of halides of said metal followed by reduction.

8. The catalyst according to claim 7, wherein said reduction is carried out in the presence of a reducing agent.

9. The catalyst according to claim 1, wherein said carrier has an amorphous structure.

10. The catalyst according to claim 1, wherein said catalyst exhibits a BET value of greater than 20 m²/g.

11. (canceled)

12. A process for producing hydrogen peroxide, comprising:
reacting hydrogen and oxygen in the presence of the catalyst according to claim 1 in a reactor.

13. A process for producing the catalyst according to claim 1, comprising:
(i) adding, to an oxide other than niobium oxide or tantalum oxide, a precursor of niobium oxide or tantalum oxide or a precursor of niobium phosphate or tantalum phosphate to form a homogeneous mixture,
(ii) converting said precursor of niobium oxide or tantalum oxide to niobium oxide or tantalum oxide or converting said precursor of niobium or tantalum phosphate to niobium phosphate or tantalum phosphate, respectively, to produce said carrier, and
(iii) depositing at least one metal selected from the group consisting of a platinum group metal, silver, gold, and a mixture thereof onto said carrier.

14. The process for producing the catalyst according to claim 13, wherein said precursor of niobium oxide or tantalum oxide is an alkoxylate of niobium or of tantalum.

15. The process for producing the catalyst according to claim 13, wherein said precursor of niobium phosphate or tantalum phosphate is niobium oxide or tantalum oxide, respectively.

16. The process for producing the catalyst according to claim 13, wherein said precursor of niobium oxide or tantalum oxide is niobium ethoxide or tantalum ethoxide, respectively.

17. The catalyst according to claim 1, wherein the catalytically active metal is palladium or a combination of palladium with platinum, silver, or gold.

18. The catalyst according to claim 1, wherein said catalyst has a content in Nb or Ta between 2 and 20 wt. %.

19. The process for producing hydrogen peroxide according to claim 12, wherein the catalyst has hydrogen peroxide decomposition and over-hydrogenation sites present on its surface; wherein the synthesis of hydrogen peroxide with the catalyst is carried out in the presence of a liquid phase; and wherein said liquid phase contains a compound capable of poisoning said hydrogen peroxide decomposition and over-hydrogenation sites of the catalyst.

20. The process for producing hydrogen peroxide according to claim 19, wherein said compound contains chlorine, bromide or iodide ions suitable to inhibit the hydrogen peroxide decomposition and over-hydrogenation sites of the catalyst.

21. The process for producing hydrogen peroxide according to claim 12, wherein the synthesis of hydrogen peroxide with the catalyst is carried out in the presence of a liquid phase; and wherein the direct synthesis of hydrogen peroxide is carried out in the absence of any inorganic acid in said liquid phase.
